(19) United States
(12) Patent Application Publication
(10) Pub. No.: US 2004/0147394 A1
(43) Pub. Date: Jul. 29, 2004

(54) Catalyst for production of hydrogen

(76) Inventors: Jon P. Wagner, Louisville, KY (US); Aaron L. Wagner, Louisville, KY (US); Yeping L. Cai, Louisville, KY (US)

Correspondence Address: SUD-CHEMIE INC., 1600 WEST HILL STREET, LOUISVILLE, KY, 40210, US

(21) Appl. No.: 10/758,552

(22) Filed: Jan. 15, 2004

Related U.S. Application Data
(63) Continuation-in-part of application No. 10/108,814, filed on Mar. 28, 2002.

(51) Int. Cl. B01J 23/00

(52) U.S. Cl. 502/325

(57) ABSTRACT

The present development is a catalyst for use in the water-gas-shift reaction. The catalyst includes a Group VIII or Group IB metal, a transition metal promoter selected from the group consisting of rhenium, niobium, silver, manganese, vanadium, molybdenum, titanium, tungsten and a combination thereof, and a ceria-based support. The support may further include gadolinium, samarium, zirconium, lithium, cesium, lanthanum, praseodymium, manganese, titanium, tungsten, neodymium or a combination thereof. A process for preparing the catalyst is also presented. In a preferred embodiment, the process involves providing “clean” precursors as starting materials in the catalyst preparation.

### CROSS-REFERENCE TO RELATED APPLICATIONS

The present application is a continuation-in-part application related to U.S. application Ser. No. 10/108,814 filed on Mar. 28, 2002 and incorporated herein in its entirety by reference.

### BACKGROUND

The present development is a high efficiency catalyst for use in the water-gas-shift reaction suitable for production of hydrogen. The catalyst includes a Group VIII or Group IB metal and a transition metal promoter on a ceria-based support. The transition metal promoter is selected from the group consisting of rhenium, niobium, silver, manganese, vanadium, molybdenum, titanium, tungsten and a combination thereof. The support may further include gadolinium, samarium, zirconium, lithium, cesium, lanthanum, praseodymium, manganese, titanium, tungsten, neodymium or a combination thereof.

Large volumes of hydrogen gas are needed for a number of important chemical reactions and since the early 1940's the water-gas-shift (WGS) reaction has represented an important step in the industrial production of hydrogen. For example, the industrial scale water-gas-shift reaction is used to increase the production of hydrogen for refinery hydro-processes and for use in the production of bulk chemicals such as ammonia, methanol, and alternative hydrocarbon fuels.

The hydrogen gas is produced from the reaction of hydrocarbons with water or oxygen and from the reaction of carbon or carbon monoxide with water. The hydrocarbons are typically reacted with water and/or oxygen in the presence of supported nickel catalysts and at high temperatures to produce a combination of carbon oxides and hydrogen gas, commonly referred to as synthesis gas or syngas (see equations 1-3):

CH₄+H₂O→CO+3 H₂ (1)

CₙHₘ+n H₂O→n CO+(n+m/2) H₂ (2)

CH₄+½O [symbol] CO+2 H₂ (3)

Alternatively, the syngas can be produced through the gasification of coal (equation 4):

C+H₂O→CO+H₂ (4)

In the subsequent water-gas-shift reaction (equation 5),

CO+H₂O [symbol] CO₂+H₂ΔH°₂₉₈=−41.1 kJ mol⁻¹ (5)

the composition of the so-called water gas can be adjusted to the desired ratio of hydrogen and carbon monoxide. (For a more detailed review of synthesis gas generation and application, see for example E. Supp, Rohstoff Kolile, Verlag Chemie, Weinheim, N.Y., 136 (1978); P. N. Hawker, Hydrocarbon Processing, 183 (1982), incorporated herein by reference).

Typically, the catalysts used in the industrial scale water-gas-shift reaction include either an iron-chromium (Fe—Cr) metal combination or a copper-zinc (Cu—Zn) metal combination. The Fe—Cr oxide catalyst works extremely well in a two stage CO conversion system for ammonia synthesis and in industrial high temperature shift (HTS) converters. The copper-based catalysts function well in systems where the CO₂ partial pressure can affect the catalyst performance, but the unsupported metallic copper catalysts or copper supported on Al₂O₃, SiO₂, MgO, pumice or Cr₂O₃ tend to have relatively short lifespans (six to nine months) and low space velocity operation (400 to 1000 h⁻¹). The addition of ZnO or ZnO—Al₂O₃ can increase the lifetime of the copper-based catalysts, but the resultant Cu—Zn catalysts generally function in a limited temperature range of from about 200° C. to about 300° C.

Although Fe—Cr and Cu—Zn catalysts are efficient when used in a commercial syngas generation facility, they are not readily adaptable for use in stationary fuel cell power units or mobile fuel cells which generate hydrogen from natural gas or liquid fuel. For example, the catalysts used in the fuel cell reformer must have a high level of activity under high space velocity operation conditions because relatively large volumes of hydrocarbons are passed over the catalyst bed in a relatively short period of time. Moreover, the catalyst bed volume must be extremely small as compared to a commercial syngas generation facility. A typical syngas generation facility uses reformer catalyst beds having average volumes ranging from about 2 m³ to about 240 m³, whereas stationary fuel cell reformer catalyst bed volumes are around 0.1 m³ and mobile fuel cell catalyst beds have volumes of about 0.01 m³. Further, the mobile fuel cell catalyst must be capable of retaining activity after exposure to condensing and oxidizing conditions during a large number of startup and shutdown cycles, and the catalyst must not require a special activation procedure or generate substantial heat when switching from reducing to oxidizing conditions at elevated temperatures. The mobile fuel cell catalyst must also tolerate an oxygen rich atmosphere in contrast to the Cu—Zn catalysts which are pyrophoric and which require steam removal and a nitrogen blanket upon reactor shut-down to minimize condensation formation and related deactivation. Because the hydrocarbon source for fuel cells may include contaminating materials such as sulfur, the catalyst should also have a relatively high poison resistance.

### SUMMARY OF THE PRESENT DEVELOPMENT

The present development is a catalyst for use in the water-gas-shift reaction. The catalyst comprises a Group VIII or Group IB metal, a transition metal promoter selected from the group consisting of rhenium, niobium, silver, manganese, vanadium, molybdenum, titanium, tungsten and a combination thereof, and a ceria-based support. The support may further include gadolinium, samarium, zirconium, lithium, cesium, lanthanum, praseodymium, manganese, titanium, tungsten, neodymium or a combination thereof.

The present development also includes a process for preparing a catalyst having a ceria support for use in the water-gas-shift reaction. The process involves providing “clean” precursors as starting materials in the catalyst preparation.

### DETAILED DESCRIPTION OF THE PRESENT DEVELOPMENT

The catalyst of the present invention is intended for use as a water-gas-shift (WGS) catalyst in a reaction suitable for conversion of hydrogen for chemical processing. The catalyst composition comprises a primary transition metal and a transition metal promoter supported on a ceria-based material. The primary transition metal is preferably present at a concentration of up to about 20 wt %. The transition metal promoter is selected from the group consisting of rhenium, niobium, silver, manganese, vanadium, molybdenum, titanium, tungsten and a combination thereof, and is preferably present in the catalyst at a concentration such that the [primary transition metal]:[promoter] is greater than 1:1, i.e. the promoter concentration must be less than the primary transition metal concentration. The cerium oxide support is present in the catalyst at a concentration of greater than about 10 wt %. Optionally, the support may include an additive, such as gadolinium, samarium, zirconium, lithium, cesium, lanthanum, praseodymium, manganese, titanium, tungsten, neodymium or a combination thereof, which may be added to the support at a concentration of from about 0 wt % to about 90 wt %.

Throughout the specification a short-hand notation is used when referring to the support. Specifically, the short-hand notation can be generalized as M1ₐM2_{b}Oₓ, wherein M1 is a first metal component, M2 is a second metal component, O is oxygen; the subscripts “a” and “b” indicate the weight percent of the components M1 and M2 relative to each other within the support; and “x” is a value appropriate to balance the charge of the support. As used herein, “surface area” refers to a BET surface area or the surface area of a particle as determined by using the Brunauer, Emmett, Teller equation for multimolecular adsorption. The term “weight percent (wt %)” as used herein refers to the relative weight each of the above specified components contributes to the combined total weight of those components.

As is known in the art, catalysts may be loaded onto a variety of substrates depending on the intended application. The present catalyst may similarly be delivered on a variety of substrates, such as monoliths, foams, spheres, or other forms as are known in the art. When delivered in these forms and for the purposes of illustration herein, unless otherwise noted, any weight added by the substrate is not included in the wt % calculations.

The Primary Transition Metal

Catalysts designed for use in fuel cell reformer beds must have a high level of activity under high space velocity operation conditions because relatively large volumes of hydrocarbons are passed over the catalyst bed in a relatively short period of time. Moreover, the stationary and mobile fuel cell catalyst bed volume is extremely small (generally being from about 0.01 m³ to about 0.1 m³) as compared to a commercial syngas generation facility (typically from about 2 m³ to about 240 m³). The primary transition metal must be selected taking into consideration the relative activity of the metal and also its selectivity, its capability to retain activity after exposure to condensing and oxidizing conditions, and its stability in an oxygen-rich and/or wet environment.

In the present development, platinum functions well as a primary transition metal for the catalyst because of its efficiency in carbon monoxide elimination and in hydrocarbon oxidation. However, other metals or combinations of metals, and particularly the Group VIII and Group IB transition metals, such as iron, cobalt, nickel, copper, ruthenium, rhodium, palladium, silver, osmium, iridium gold, and cadmium and rhenium may be substituted for or may be added to the platinum as appropriate to alter the equilibrium product mix.

The primary transition metal—as a single metal or as a combination of metals—is present in the catalyst composition at a predetermined concentration (“[Primary TM]”) of up to about 20 wt %, including the weight of the primary transition metal. The concentration selected is dependent on the anticipated reaction conditions and the desired product mixture, and may be optimized using known experimental procedures, such as performance versus concentration studies, as are known in the art.

The Transition Metal Promoter

It is known in the art that promoters may be added to a catalyst formulation to improve selected properties of the catalyst or to modify the catalyst activity and/or selectivity. In the present invention, the transition metal promoter is selected from the group consisting of lithium, potassium, rubidium, cesium, titanium, vanadium, niobium, molybdenum, tungsten, manganese, rhenium, ruthenium, rhodium, iridium, silver, the Group VIII metals, the Group IB metals and a combination thereof, and is added at a concentration such that the resulting catalyst has a [Primary TM]:[Promoter] that is greater than 1:1, i.e. the transition metal promoter concentration (“[Promoter]”) is lower than the concentration of the primary transition metal.

When platinum is selected as the primary transition metal, rhenium is a particularly effective promoter for the conversion of carbon monoxide. However, other transition metal promoters may be substituted for or may be added to the rhenium as warranted by the reaction conditions. Further, when a primary transition metal other than platinum is selected, the optimum promoter may be rhenium, or rhenium used in combination with another transition metal promoter, or one or more of the other transition metal promoters as appropriate for the specific application.

The Support

The water-gas-shift catalyst support of the present invention comprises a ceria-based material that is present at a concentration of greater than about 10 wt %. Cerium oxide is generally recognized as an efficient support for water-gas-shift catalysts because ceria can essentially function as a promoter. For example, in general, precious metals such as platinum, rhodium and palladium are not good water gas shift catalysts because they are not easily oxidized by water. However, it has been shown that when these metals are ceria supported, they are active shift catalysts. Further, the cerium oxide has a surface area of from about 10 m²/g to about 200 m²/g and a crystallite size range which appears to facilitate the water-gas-shift reaction.

The water-gas-shift reaction, and particularly the CO conversion, can also be affected by the inclusion of additives to the cerium oxide. To enhance the CeO₂ performance, additives such as gadolinium, samarium, zirconium, lithium, cesium, lanthanum, praseodymium, manganese, titanium, tungsten, neodymium or a combination thereof may be used in the ceria-based support. Some representative examples of supports, without limitation, would include Ce_{0.7}Gd_{0.2}Zr_{0.1}Oₓ, Ce_{0.7}Sm_{0.2}Zr_{0.1}Oₓ, Ce_{0.6}Mn_{0.4}O₂, cerium metal, CeO₂/Al₂O₃, 20%ZrO₂/80% TiO₂, 50%ZrO₂/50% TiO₂, 80%ZrO₂/20% TiO₂. The additive is generally present at a concentration of from about 0 wt % to about 90 wt %. Although the cerium based supports are preferred for the present invention, non-cerium based supports known in the art can also be used to deliver the Group VIII or Group IB metal and the transition metal promoter.

Mixed cerium zirconium oxide is a preferred support for the platinum/rhenium containing catalyst. The cerium to zirconium ratio can be varied as necessary to optimize the catalyst performance. In the present development using a platinum primary metal and a rhenium promoter, it has been found that a cerium zirconium oxide support which is rich in zirconium, i.e. in which the weight percent added to the support by the zirconium is greater than the weight percent added to the support by the cerium, demonstrates a surprisingly improved level of CO conversion without concomitant significant methane formation. For example, for the catalyst comprising about 3 wt % platinum and about 1 wt % rhenium, a preferred support is Ce_{0.25}Zr_{0.75}O₂ having a surface area greater than about 10 m²/g, and preferably having a surface area of from about 50 m²/g to about 200 m²/g. Alternatively, a cerium zirconium oxide support which is rich in cerium, such as Ce_{0.8}Zr_{0.2}O₂ having a surface area greater than about 30 m²/g, and preferably having a surface area of from about 50 m²/g to about 150 m²/g, has also shown acceptable levels of CO conversion without concomitant significant methane formation. Further it is preferred that the support be essentially absent of known catalytic poisons, such as sulfur, which are known in the art.

Precursor Ligands and Catalyst Preparation

The preparation method can affect the performance of the water-gas-shift catalyst. For example, as is known in the art, the primary transition metal(s) and the transition metal promoter are generally provided in the form of a metal-based precursor for impregnation on a support material. The metal-based precursor generally includes one or more substituents or ligands which separate from the metal when the metal is impregnated on the support material. Although the ligands of the precursor are not believed to be active materials of the finished catalyst, they may affect how the support receives the transition metal and/or the promoter. Further, as is known in the art, certain ligands or substituents may negatively affect the support surface and may effectively “poison” the catalyst.

In the present development, the primary transition metal and the promoter are preferably based on clean precursors, wherein the term “clean” refers to a precursor which does not include one or more potentially catalytically poisonous substituents or to a precursor from which the potentially catalytically poisonous substituents can be removed with relative ease during the catalyst preparation process. As is known in the art, a potentially poisonous substituent is any element which can adsorb to the support surface in such a manner so as to prevent one or more sites on the support surface from participating in the desired catalytic reaction. For water-gas-shift catalysts, some commonly recognized poisons are sulfur, chlorine, sodium, bromine, iodine or combinations thereof. Depending on the particular support material selected, other substituents may be included in the list of potential poisons based on their reactivity.

In the present development, some representative “clean” precursors would include complexes having ligands selected from the group consisting of ammonia, primary amines, secondary amines, tertiary amines, quaternary amines, nitrates, nitrites, hydroxyl groups, carbonyls, carbonates, aqua ions, oxides, oxylates, and combinations thereof. For example, for the platinum containing catalysts, the platinum may be delivered to the support in the form of a platinum tetra-amine hydroxide solution, a platinum tetra-amine nitrate, a platinum di-amine nitrate, platinum oxalate, platinum nitrate or other similar platinum-based complexes. When the platinum is delivered to the support in the form of the platinum tetra-amine hydroxide solution the resultant water-gas-shift catalyst has a slightly greater carbon monoxide conversion profile than when other precursor materials are used. Similarly, the rhenium may be provided as a clean precursor in the form of ammonium perrhenate or as one of the known rhenium oxide complexes, such as ReO₂, ReO₃ or Re₂O₇.

Alternatively, the primary transition metal precursor and the promoter precursor may include substituents which may potentially be poisonous to the catalyst, but which can be removed with relative ease during the catalyst production process to a sufficient extent so as to make the catalyst “clean.” For example, as indicated in Example 1 or Example 1A (below) and several related examples herein, chloroplatinic acid may be used as a platinum source with the chlorine being removed by air calcination. Depending on the concentration of chlorine present in the catalyst following calcination, the catalyst may be washed by various methods known in the art such as water washing, washing with basic solution, steam calcination, reducing the catalyst with hydrogen and/or other reducing agents followed by washing.

As is known in the art, catalysts are frequently calcined to drive off volatile matter or to effect changes in the catalyst. The calcination time and temperature can affect the catalyst performance, and it is recommended that the calcination conditions be optimized for the particular desired catalyst composition and intended use. In the present invention, the catalyst is calcined after the primary transition metal is added to the support. When the primary transition metal is platinum which is delivered to the catalyst in the form of chloroplatinic acid, and the support comprises ceria, the catalyst is calcined in a furnace set at from about 300° C. to about 500° C. for from less than about 1 hour to greater than about 16 hours with a heating rate of about 10° C. per minute in air. If a transition metal promoter is added to the primary transition metal catalyst, the catalyst is calcined after the addition of the promoter in a furnace set at from about 300° C. to about 500° C. for from less than about 1 hour to greater than about 3 hours with a heating rate of about 10° C. per minute in air.

The catalyst may be delivered on substrates other than monoliths, foams, spheres, or similar substrates. For example, the present catalyst may be delivered in the form of extrudates, tabs, pellets, multi-passage substrates or similarly prepared materials. When delivered in these forms, the catalytic activity is dependent on the relative amounts of the active components on the substrate surface because it is essentially only the surface components which can participate in the water-gas-shift reaction. As is known in the art, when delivered in these alternative forms, the concentration of the components is more accurately referred to in terms of the surface concentration or in grams of specific metal per liter of catalyst.

There are numerous ways in which metals can be combined with supports to produce catalysts. In the examples presented herein, the metals have been combined with the support using known impregnation techniques. However, other methods may be used, such as co-precipitation, sol-gel, vapor deposition, chemical vapor deposition, deposition precipitation, sequential precipitation, mechanical mixing, decomposition and other methods which are known in the art. Any means for combining metals with a support to produce a catalyst which has the composition described herein is believed to fall within the scope of this invention.

Exemplary Embodiments

The catalyst of the present invention can be prepared following the procedures set forth in Examples 1, 1A, 2 and 2A. These examples are not to be taken as limiting the present invention in any regard. Examples 1 and 1A set forth representative procedures for adding the primary transition metal to the support. Examples 2 and 2A set forth representative procedures for adding the transition metal promoter to the primary transition metal/support.

### EXAMPLE 1

A 100 g sample of a water-gas-shift catalyst having about 3 wt % platinum on a cerium oxide (CeO₂) support is prepared by the following steps. Samples of a cerium oxide support (CeO₂) having a surface area of greater than about 50 m²/g are evaluated to determine loss of ignition, x, and to establish the wetting factor, y. Approximately (100+x)g of cerium oxide is then placed in an evaporation dish and a sufficient amount of chloroplatinic acid is added to the CeO₂ to deliver approximately 3% by weight platinum metal (starting with a 100 g CeO₂ sample, about 3.039 g Pt must be added). For easier handling and better distribution of the platinum, the chloroplatinic acid is diluted with y g of deionized water (or other appropriate solvent) before being added to the CeO₂. The platinum/CeO₂ combination is stirred occasionally while drying over a steam bath to form an impregnated powder. The impregnated powder is dried in an oven set at about 100 ° C. for from about 4 hours to about 24 hours, and the powder is then calcined in a furnace set at from about 300° C. to about 500° C. for from about 3 hours to about 24 hours with a heating rate of about 10° C. per minute in air. The powder is then cooled by decreasing the furnace temperature at a rate of about 60° C. per minute and the powder is returned to an evaporation dish. Approximately 100 g of a catalyst having a cerium oxide support with about 3 wt % platinum metal impregnated on the support surface, a calcined Pt/CeO₂ powder, is produced.

### EXAMPLE 1A

A 100 g sample of a water-gas-shift catalyst having about 3 wt % platinum on a cerium oxide (CeO₂) support is prepared by determining loss of ignition, x, and determining the amount of chloroplatinic acid sufficient to deliver approximately 3 wt % platinum metal as noted in Example 1. For easier handling and better distribution of the platinum, the chloroplatinic acid is diluted with y g of deionized water (or other appropriate solvent) before being added to the CeO₂. The liquid and CeO₂ powder are mixed together in a flask with a magnetic stir bar. The slurry is stirred vigorously. After about one hour, 1M NH₄OH solution is added until the pH of the entire slurry is between 7.5 and 8.5. The slurry is allowed to stir for about ₂₄ hours and is then filtered over Waltham #1 filter paper. The filtrate is dried at about 100° C. for about 24 hours and the resulting powder is calcined at about 500° C. for from about 2 hours to about 24 hours.

### EXAMPLE 2

Samples of water-gas-shift catalysts are prepared according to the general procedure of Example 1 or Example 1A except the cerium oxide support (CeO₂) is replaced with a cerium zirconium oxide (CZO) support having a stoichiometry of approximately 3 cerium: 1 zirconium (Ce_{0.75}Zr_{0.25}O₂) and having a surface area of greater than about 50 m²/g, so that a calcined Pt/CZO powder is produced. The calcined Pt/CZO powder is then subjected to a second impregnation process using ammonium perrhenate. For the second impregnation, a sufficient amount of ammonium perrhenate to deliver about 1 wt % rhenium metal (starting with a 100 g CZO sample, about 1.01 g Re must be added, which is about 1.45 g NH₄ReO₄ crystals) is dissolved in a sufficient quantity of deionized water to make y grams of solution. The rhenium solution is added to the calcined Pt/CZO powder, stirred over a steam bath until dry, further dried in an oven set at about 100° C. for from about 4 hours to about 24 hours, and the powder is then calcined in a furnace set at from about 300° C. to about 500° C. for from about 1 hours to about 3 hours with a heating rate of about 10° C. per minute in air. The powder is then cooled by decreasing the furnace temperature at a rate of about 60° C. per minute. Approximately 100 g of a catalyst having a cerium zirconium oxide support with about 3 wt % platinum metal and about 1 wt % rhenium metal impregnated on the support surface is produced.

### EXAMPLE 2A

Samples of water-gas-shift catalysts are prepared according to the general procedure of Example 2 except that chloroplatinic acid is replaced by platinum tetra-amine hydroxide. The amount of platinum tetra-amine hydroxide may be altered to deliver the desired platinum concentration.

It is understood that variations may be made which would fall within the scope of this development. For example, precursor materials other than those expressly listed may be employed to deliver the desired primary transition metal(s) and/or the promoter(s), or the processing conditions may be varied without exceeding the scope of this development. Further, the active catalyst may be delivered in a form that includes essentially inert components. In the latter case, the inert components should be disregarded in any calculations when determining the relative weight percentages of the active components.

What is claimed is:

1. A catalyst suitable for production of hydrogen, said catalyst consisting essentially of:
a. a primary transition metal selected from the group consisting of a Group VIII metal, a Group IB metal, cadmium and a combination thereof, said primary transition metal being present at a predetermined concentration [Primary TM];
b. a transition metal promoter present at a predetermined concentration [Promoter] selected such that a ratio defined by [Primary TM]:[Promoter] is greater than 1:1; and
c. a support material comprising cerium oxide and an additive selected from the group consisting of gadolinium, samarium, zirconium, lithium, cesium, lanthanum, praseodymium, manganese, titanium, tungsten, neodymium and a combination thereof,
wherein said transition metal and said promoter are combined with said support material to form said catalyst.

2. The catalyst of claim 1 wherein said primary transition metal is present at a concentration of up to about 20 wt %.

3. The catalyst of claim 2 wherein said primary transition metal is selected from the group consisting of iron, cobalt, nickel, copper, ruthenium, rhodium, palladium, silver, osmium, iridium, platinum, gold, cadmium and a combination thereof.

4. The catalyst of claim 1 wherein said promoter is selected from the group consisting of lithium, potassium, rubidium, cesium, titanium, vanadium, niobium, molybdenum, tungsten, manganese, rhenium, iron, cobalt, nickel, copper, ruthenium, rhodium, palladium, silver, osmium, iridium, platinum, gold, and a combination thereof.

5. The catalyst of claim 1 wherein said support material comprises cerium oxide at a concentration of greater than about 10 wt %.

6. The catalyst of claim 1 wherein said support material has a surface area of from about 10 m²/g to about 200 m²/g.

7. The catalyst of claim 1 wherein said catalyst is combined with a substrate, wherein said substrate is a monolith, a foam, a sphere, an extrudate, a tab, a pellet, a multi-passage substrate or a combination thereof.

8. A catalyst suitable for conversion of hydrogen, said catalyst comprising:
a. a primary transition metal present at a predetermined concentration [Primary TM] of up to about 20 wt % and selected from the group consisting of iron, cobalt, nickel, copper, ruthenium, rhodium, palladium, silver, osmium, iridium, platinum, gold, cadmium and a combination thereof;
b. a transition metal promoter present at a predetermined concentration [Promoter] and selected from the group consisting of lithium, potassium, rubidium, cesium, titanium, vanadium, niobium, molybdenum, tungsten, manganese, rhenium, iron, cobalt, nickel, copper, ruthenium, rhodium, palladium, silver, osmium, iridium, platinum, gold, and a combination thereof; and
c. a support material comprising cerium oxide at a concentration of greater than about 10 wt %,
wherein said transition metal and said promoter are combined with said support material to form said catalyst and a ratio defined by [Primary TM]:[Promoter] is greater than 1:1.

9. The catalyst of claim 8 wherein said support material further includes an additive selected from the group consisting of gadolinium, samarium, zirconium, lithium, cesium, lanthanum, praseodymium, manganese, titanium, tungsten, neodymium and a combination thereof.

10. The catalyst of claim 9 wherein said additive is present at a concentration of from about 0 wt % to about 90 wt %.

11. The catalyst of claim 8 wherein said support material is a mixed cerium zirconium oxide comprising zirconium at a higher weight percent than cerium.

12. The catalyst of claim 8 wherein said support material is a mixed cerium zirconium oxide comprising cerium at a higher weight percent than zirconium.

13. A catalyst suitable for conversion of hydrogen for chemical processing, said catalyst comprising:
a. a primary transition metal present at a predetermined concentration [Primary TM] of up to about 20 wt % and selected from the group consisting of iron, cobalt, nickel, copper, ruthenium, rhodium, palladium, silver, osmium, iridium, platinum, gold, cadmium and a combination thereof;
b. a transition metal promoter present at a predetermined concentration [Promoter] and selected from the group consisting of lithium, potassium, rubidium, cesium, titanium, vanadium, niobium, molybdenum, tungsten, manganese, rhenium, iron, cobalt, nickel, copper, ruthenium, rhodium, palladium, silver, osmium, iridium, platinum, gold, and a combination thereof; and
c. a support material comprising cerium oxide at a concentration of greater than about 10 wt %,
wherein said transition metal is impregnated onto the support material to form a transition metal inclusive support and said inclusive support is then calcined; and said transition metal promoter is impregnated onto said inclusive support and calcined to form a promoter inclusive catalyst.

14. The catalyst of claim 13 wherein said primary transition metal is delivered to said support as a solvent containing a predetermined concentration of a first transition metal precursor defined as a transition metal complex having at least one ligand and wherein said ligand is absent of sulfur, chlorine, sodium, bromine, and iodine, and wherein said promoter is delivered to said transition metal inclusive support as a solvent containing a predetermined concentration of said a second transition metal precursor defined as a transition metal complex having at least one ligand and wherein said ligand is absent of sulfur, chlorine, sodium, bromine, and iodine.

15. The catalyst of claim 14 wherein said first transition metal precursor is a transition metal complex having ligands selected from the group consisting of ammonia, primary amines, secondary amines, tertiary amines, quaternary amines, nitrates, nitrites, hydroxyl groups, carbonyls, carbonates, aqua ions, oxides, oxylates, and combinations thereof.

16. The catalyst of claim 14 wherein said first transition metal precursor is selected from the group consisting of platinum tetra-amine hydroxide, platinum tetra-amine nitrate, platinum di-amine nitrate and a combination thereof.

17. The catalyst of claim 14 wherein said second transition metal precursor is selected from the group consisting of ammonium perrhenate, a rhenium oxide complex, ReO₂, ReO₃ or Re₂O₇.

18. The catalyst of claim 13 wherein said support material further includes an additive present at a concentration of up to about 90 wt % and selected from the group consisting of gadolinium, samarium, zirconium, lithium, cesium, lanthanum, praseodymium, manganese, titanium, tungsten, neodymium and a combination thereof.

19. The catalyst of claim 13 wherein said [Primary TM] and [Promoter] define a ratio [Primary TM]:[Promoter] that is greater than 1:1.

20. The catalyst of claim 13 wherein said catalyst is combined with a substrate, wherein said substrate is a monolith, a foam, a sphere, an extrudate, a tab, a pellet, a multi-passage substrate or a combination thereof.
